(19) United States
(12) Patent Application Publication
(10) Pub. No.: US 2013/0227917 A1
(43) Pub. Date: Sep. 5, 2013

(54) ENVIRONMENTAL PROCESS CONTAINMENT BAG AND METHOD OF USE

(71) Applicant: FIELD SPECIALTIES, INC., Hitchcock, TX (US)

(72) Inventors: Michael John Joy, Newbury Park, CA (US); James Steven Carlisle, Santa Fe, TX (US)

(73) Assignee: FIELD SPECIALTIES, INC., Hitchcock, TX (US)

(21) Appl. No.: 13/784,817

(22) Filed: Mar. 4, 2013

Related U.S. Application Data
(60) Provisional application No. 61/605,916, filed on Mar. 2, 2012.

(51) Int. Cl. B65D 33/00; F16L 55/168

(52) U.S. Cl. CPC B65D 33/00; F16L 55/168
USPC 53/469; 383/66; 383/106; 285/13

(57) ABSTRACT

A flexible bag assembly includes a body which has a first end and a second end; a closure system for opening or closing of the body between the first end and the second end along a seam; and at least one tubular section on at least one end of the body. The tubular section is configured to wrap around a pipe portion connected to a container. Systems and methods of using such flexible bag assembly for environmental process containment are disclosed herein.

### CROSS-REFERENCE TO RELATED APPLICATION(S)

This application claims priority to and the benefit of U.S. Provisional Application No. 61/605916, filed Mar. 2, 2012, entitled ENVIRONMENTAL PROCESS CONTAINMENT—Provisional Patent Description, the entire content of which is incorporated herein by reference.

### TECHNICAL FIELD

The present disclosure is related to environmental process containment bags, systems and methods of using the same.

### BACKGROUND

There are many industrial applications that involve the storage or transfer of hazardous media. Such media includes, for example, solid, vapor, or fluid materials that have negative health effects, explosive in nature, strong chemical reactivity, environmental issues, etc. Sometimes such media needs to be transferred from one vessel, pipeline or other conveyance or storage device to another. Other times such media needs to be transferred to the applicable process equipment, or to another device that is capable of destroying the subject media for environmental control purposes. During the storage or transfer process, the container or conveyance device may need to be opened for cleaning, maintenance, or service due to unintentional equipment malfunctions such as leaks in pipes, connections, flanges and valves. Due to the hazardous nature of such media, it is desirable to contain it from entering the atmosphere when the container or conveyance device is being worked on.

Therefore, there is a need for a novel system and method for environmental process containment.

### SUMMARY

The present invention provides a bag and a system for environmental process containment. In one embodiment of the invention, a flexible bag assembly includes a body which has a first end and a second end; a closure system for opening or closing of the body between the first end and the second end along a seam; and at least one tubular section on one end of the body. The tubular section is configured to wrap around a pipe portion connected to a container.

In another embodiment of the invention, a system for environmental process containment includes a bag assembly which has a body and the body has a first end and a second end; a closure system for opening or closing of the body between the first end and the second end along a seam; and at least one tubular section on one end of the body; wherein the tubular section is configured to wrap around a pipeline connected to a container.

In a further embodiment of the invention, a method of containing hazardous media from a container which has a body and at least one pipe connected to the body includes the steps of wrapping a flexible bag assembly around the body of the container and closing the body of the bag assembly around the body of the container using a closure system.

### BRIEF DESCRIPTION OF THE DRAWINGS

FIG. 1a is a schematic side view illustration of a bag assembly.

FIG. 1b is a cross sectional end view of the bag assembly of FIG. 1a in an open position along the line B-B.

FIG. 2 is a schematic illustration of a cross sectional end view of various embodiments of a closure system (2a, hook and loop system, 2b, captive fastener system, 2c, lacing cord system) cutting along line A-A in FIG. 1a.

FIG. 3 is a schematic illustration of a flap system of the bag assembly with the flap open (3a) and closed (3b).

FIG. 4a is a schematic illustration of a side view of a bag assembly in use with a container.

FIG. 4b is a schematic illustration of a side view an alternative embodiment of a bag assembly in use with another container.

FIG. 4c is a schematic illustration of a side view of a portion of an alternative embodiment of a bag assembly with a funnel-shaped section.

FIG. 5 illustrates an end view of a bag assembly with some exemplary configurations of access holes.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein.

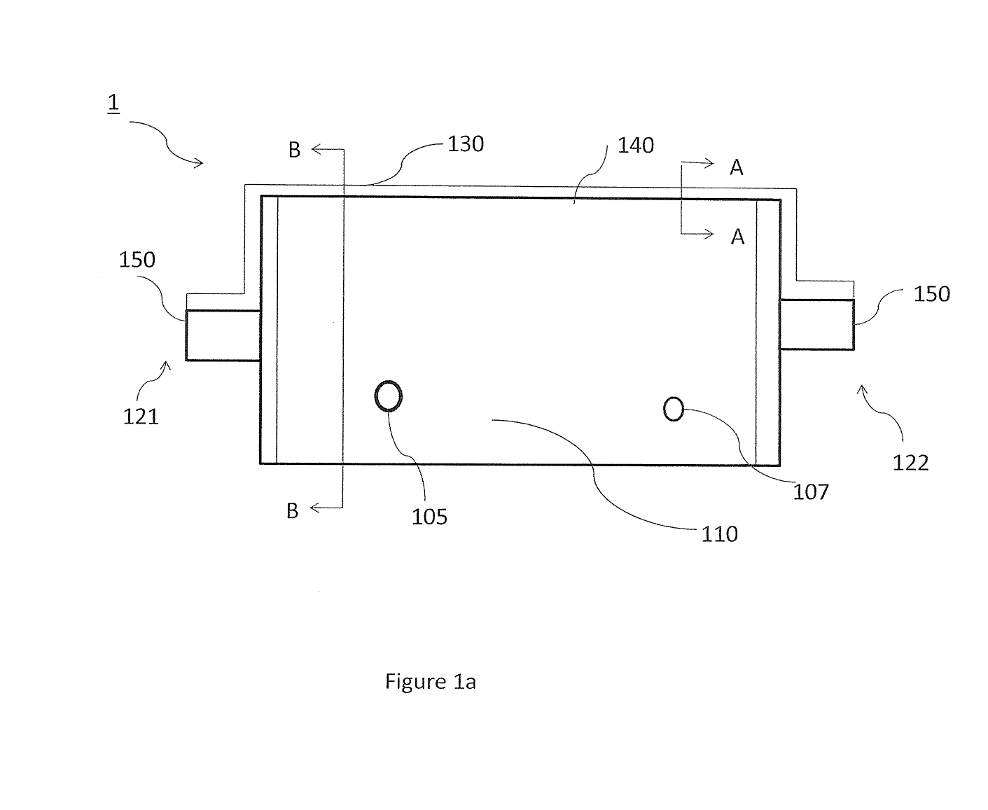

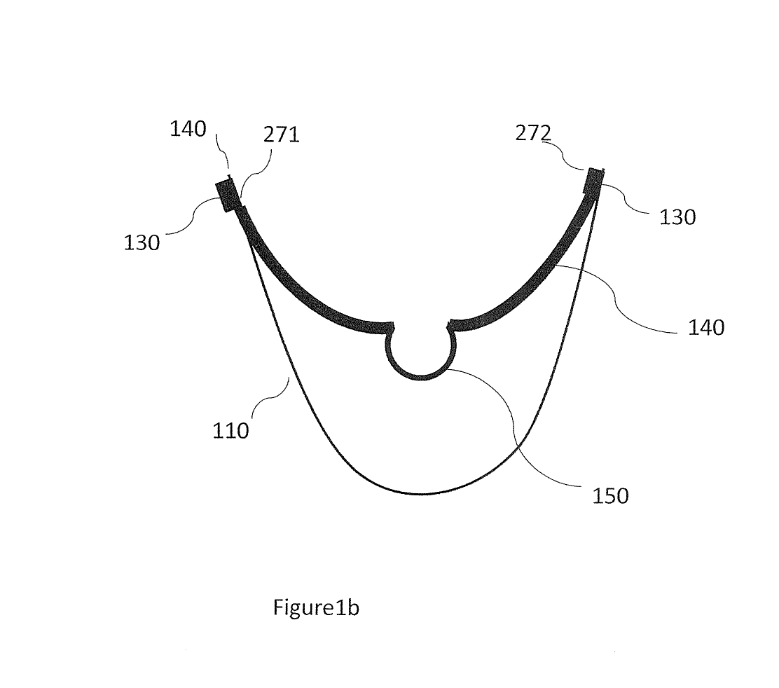

Referring to FIGS. 1a and 1b, an embodiment of the flexible bag assembly 1 includes a bag body 110, a first end 121 and a second end 122, a closure system 130 for opening or closing the body between the first end and the second end along a seam 140 having a first side 271 and a second side 272, and at least one tubular section 150 on at least one end of the body. The embodiment of these figures has two tubular sections, one at each end. The tubular sections are used to wrap around pipes connected to a container to be worked on. However, it should be understood that only one tubular section may be present or that more than two tubular sections may be present depending upon the number of pipes involved, and that they may be orientated as needed. Moreover, as used herein “container” should be understood to cover any structure capable of containing or carrying media, including, but not limited to pipes, connections, fittings, flanges, valves, tanks and the like.

The embodiment of FIGS. 1a and 1b shows the seam located at the top of the assembly. However, it should be understood that the seam may be located elsewhere. For example, the seam may be along a side or at the bottom of the assembly.

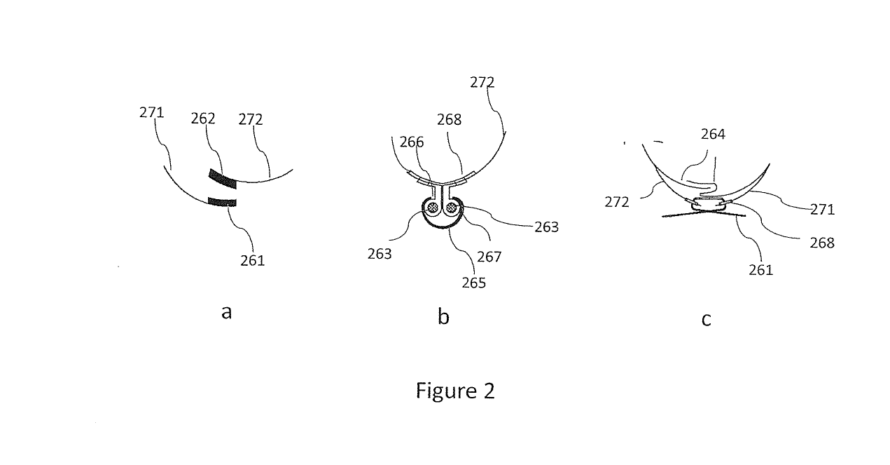

The closure system can be any suitable systems for opening or closing the body between the first end 121 and the second end 122. FIG. 2 shows some exemplary embodiments of such closure systems. FIG. 2a shows a hook and loop system having a hook portion 261 on one side 271 of the seam, and a loop portion 262 on another side 272 of the seam. Both the hook and loop portions have a length the same as the length of the seam. The hook and loop portions overlap and interlock to form the seam 140 upon closing of the body. The hook portion can be separated from the loop portion upon opening of the seam, which is shown in FIG. 2a. FIG. 2b shows a captive fastener system having a housing 265 with a narrower opening 266 and a wider inside 267 on one side 271 of the seam. On the other side 272 of the seam, there are two lips 263 each connected to an elastic spring 268. For closing the bag, the two lips are squeezed closer to each other and fit into the housing 265. Once inside the housing 265, the two lips are released from the squeezed state and spring to a configuration where they cannot slip out of the opening of the housing. For opening the seam, the two lips can be squeezed closer to each other until they can be slipped out of the housing. FIG. 2c shows a lacing cord system. On each side of the seam, a reinforced seam piece 268 has series of holes distributed along the length of the seam on both sides of the seam. A thread or cord 269 passes through the series of holes from one side of the seam to the other side of the seam alternately. To close the two sides of the bag together, the thread is pulled tight. To open the bag, the thread can be loosened or even removed. There is a tongue assembly 264 located beneath the seam that will form a complete closure of the bag when the thread is pulled tight. Other configurations of the holes may include eyelets or loops or hooks.

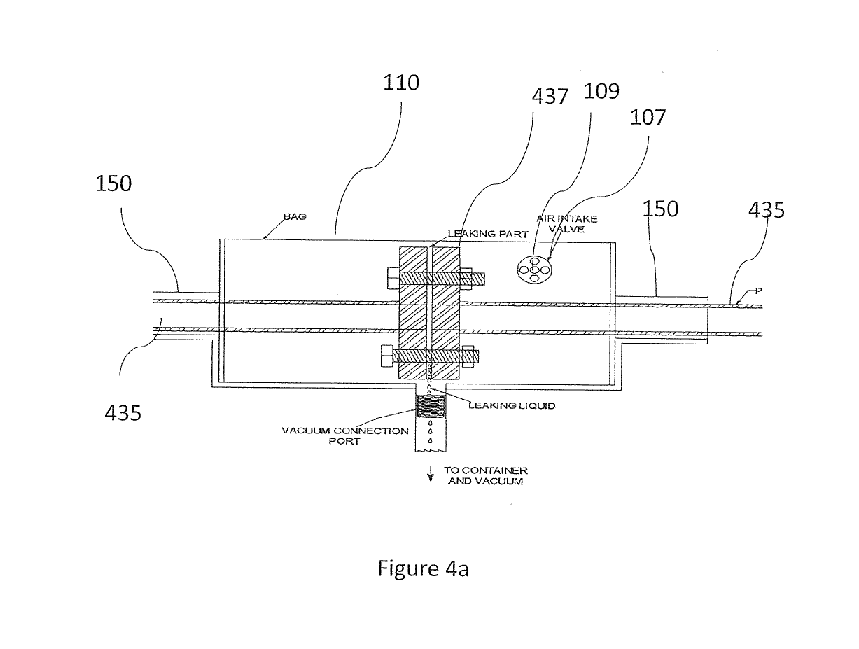

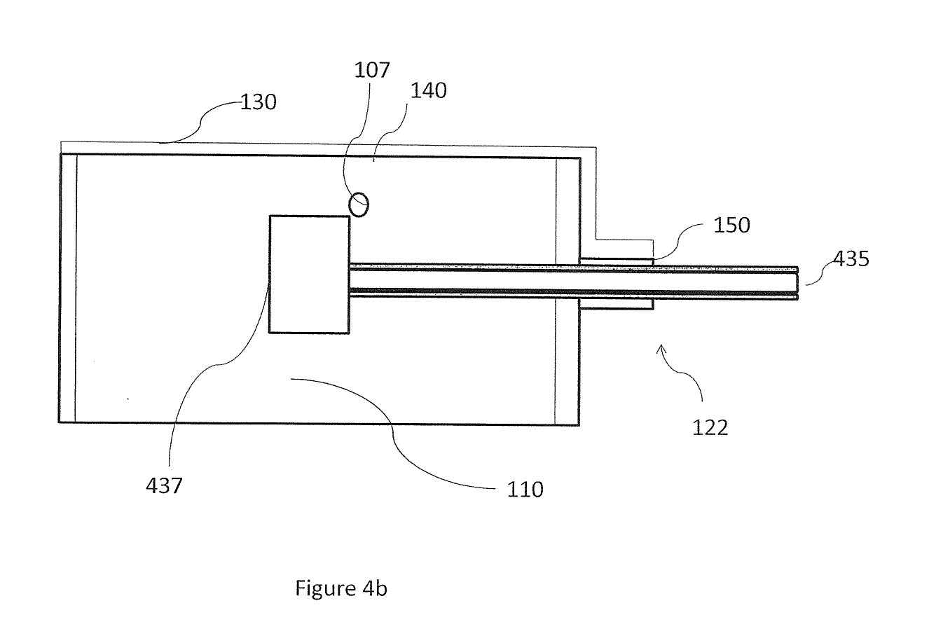

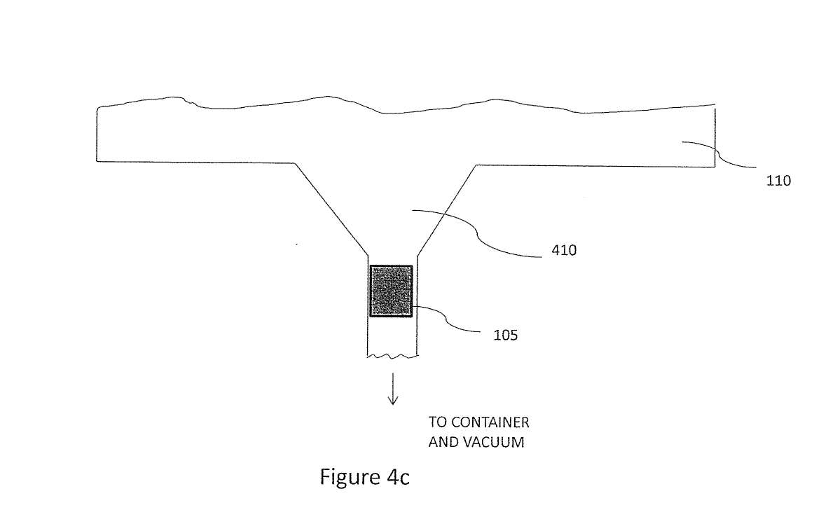

FIG. 4a shows an exemplary application of the flexible bag assembly. The bag assembly is wrapped around a leaking part 437 with a pipeline 435 on each side of the leaking part. FIG. 4b shows another exemplary application of the flexible bag assembly. The bag assembly is wrapped around a leaking part 437 with only one pipeline 435 connected to it, and the bag assembly has only one tubular section 150 accordingly.

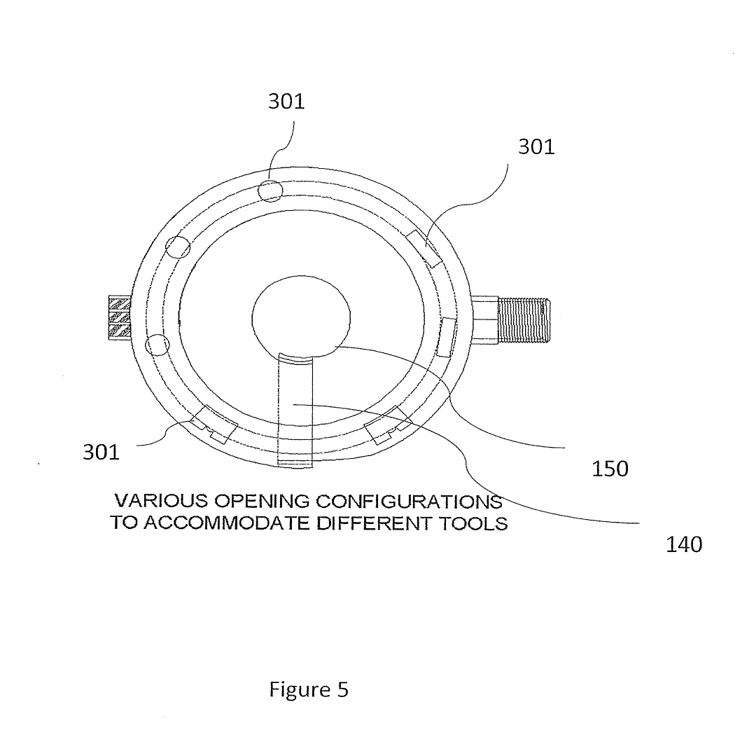

The flexible bag assembly can further include access holes for reaching tools into the bag to interact with the leaking part when performing the maintenance. The access holes can be of various shapes to accommodate various tools needed. FIG. 5 shows some exemplary configurations of the access holes. The access holes can be used to allow for the removal of flange bolts for ASME/ANSI flanges Class 150 to Class 2500, or other types and sizes in nominal pipe sizes ¼ and larger.

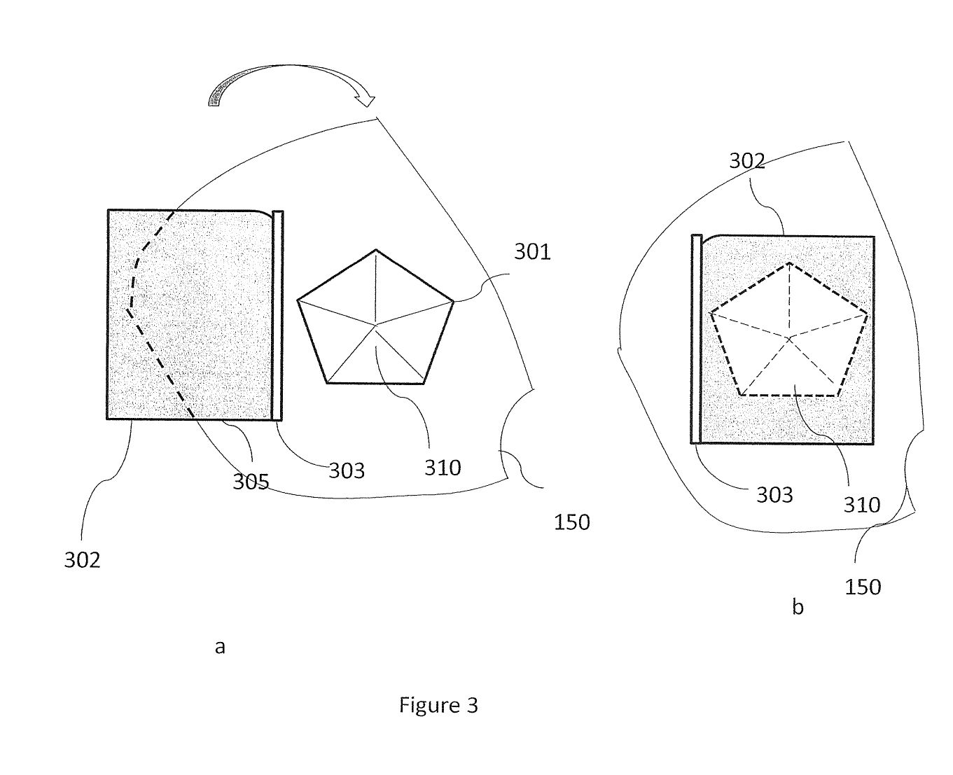

In one embodiment of the invention, as shown in FIG. 3, each access hole 301 has a resealable flap 302 attached to the bag through a joint 303 to cover over it when not needed during the operation (FIG. 3b). In another embodiment, one resealable flap can be big enough to cover multiple access holes. The access holes can be formed through cutting off a portion (e.g. the pentagon shape in FIG. 3a) of the bag, or by cutting the material into plurality of flaps 310 disconnected around the center that will separate apart to allow a tool to pass through under slight pushing from the tool. The access holes can be formed around the periphery of the bag assembly, or any location that allows easy access to the sites to be worked on.

The resealable flap can be attached to the flexible bag assembly at joint 303 using any suitable bonding means, including adhesives, welding, heat sealing, solvent bonding, etc. The resealable flap can have a pressure sensitive coating over its face 305 to allow repeated opening and closing.

The flexible bag can further include a vacuum port 105 and an air intake valve 107. The vacuum port can be connected to a vacuum source to draw the hazardous liquid and or vapor away. The air intake valve can be used to adjust the level of vacuum inside the bag to allow a small negative pressure inside the bag. When vacuum is used, the flexible bag assembly may wrap around the container under the negative pressure, forming a good seal around the container. However, it should be understood that an air-tight seal is not needed. It is usually enough to have the fit be such that most liquids will be physically contained and a negative pressure established relative to the outside environment so that most vapor is maintained inside the bag.

Depending on the size of the container, a bag assembly with an appropriate size and shape and with appropriate sized vacuum port and air intake valve can be selected. For example, if the container is small, such as in a “Leak Detection and Repair” (LDAR) operation commonly in use in oil refineries and manufacturing plants on leaking valves and connections, a small sized vacuum connection and air intake valve, such as ⅜″ in diameter, can be used. On the other hand, if the operation is on a larger scale, such as in “tank blinding” or opening large pipes at flanged fittings, the vacuum port and air intake valve can be a larger size, such as 2″ in diameter to allow for connection to large vapor extraction and destruction systems such as an IC system, flares, etc. In each case, a restricting valve 109 may be applied to the air intake valve to regulate the intake air flow.

The flexible bag assembly or portions thereof can be made of a material that is transparent, or translucent in color. This can aid in allowing maintenance work to be performed through the bag access holes. Such a material can be selected from fabric, fluoropolymer such as Teflon PTFE, Teflon FEP, polypropylene, polyethylene, or polyvinyl chloride. The selection of the bag material depends on chemical composition and the thermal requirement of the media, as well as the manufacturing attributes of the material compounds. The bag material should not react with the hazardous material to be processed and should not deteriorate under the operating conditions.

The flexible bag assembly can be manufactured from polymeric film or fabric parts that are cut to flat patterns. These flat patterns can then be sewn, stitched together or joined with heat sealed seams into a clam-shell configuration with a closure system along the seam. The flexible bag assembly can be of various shapes and sizes suitable for each specific operation. For example, when the operation is on a connection with a leaking valve connected to two pipeline in two opposite side of valve, the flexible bag assembly can have two tubular sections for wrapping around the two pipelines, as shown in FIG. 4a. The rest of the body of the bag assembly can be in a tubular shape of a size large enough to enclose the leaking valve, or in other shapes such as squares, rectangles, or irregularly shaped. For other applications, only one tubular section may be needed as shown in FIG. 4b, rather than two.

The bag assembly can be used on various applications, such as to wrap around a leaking pipe flange, a leaking valve, or a bad pipe connection.

In one embodiment of the invention, the bag assembly further includes a collection container for collecting the hazardous media from the leaking container. When vacuum is used, the collecting container can be attached through the tubing that also connects the vacuum source to the bag assembly through the vacuum port. In one exemplary embodiment, a canister with adsorption media to capture volatile organic compounds is further attached to the bag assembly. Exemplary adsorption media includes carbon, resins or zeolites. The canister can be open to atmosphere on the outlet, opposite to the side where it is connected to the bag assembly.

In other embodiments of the invention, a portion of the bag assembly can further have a shape with funnel-shaped or bowl-shaped extensions 410 designed to aid in the collection and removal of certain solids and liquids. For example, in one embodiment as shown in FIG. 4c, the vacuum port may be located at the bottom of a funnel-shaped extension so that liquid to be removed will collect above the vacuum port. In such an embodiment, a screen or filter may be provided at the vacuum port to prevent any solid material from getting into the vacuum system.

The bag assembly can be used in a system for environmental process containment. It can be used to arrest, contain and allow for the safe removal of hazardous solids, vapors and or liquids in the event of an equipment malfunction causing leakage or during cleaning or planned maintenance to preclude such leakage.

A process of using the bag assembly of the present invention to contain hazardous media from a container includes wrapping the flexible bag assembly around the container, with the tubular section wrapping around a pipeline connected to the container, and closing the bag with the closure system. In one embodiment, a vacuum source can be connected to a vacuum port of the bag. The bag, including the tubular section can be sealed around the container upon the application of negative pressure, due to the flexible nature of the bag.

Although limited embodiments of the flexible bag assembly for environmental process containment have been specifically described and illustrated herein, many modifications and variations will be apparent to those skilled in the art. Accordingly, it is to be understood that flexible bag assemblies constructed according to principles of this invention may be embodied other than as specifically described herein. The invention is also defined in the following claims and equivalents thereof.

What is claimed is:

1. A flexible bag assembly, comprising:
a body, the body having a first end and a second end;
a closure system for opening or closing of the body between the first end and the second end along a seam; and
at least one tubular section on at least one end of the body; wherein the tubular section is configured to wrap around a pipe portion connected to a container.

2. The flexible bag assembly of claim 1, further comprising:
at least one access holes covered by a resealable flap.

3. The flexible bag assembly of claim 1, wherein the body comprises a material that is transparent or translucent.

4. The flexible bag assembly of claim 1, wherein the closure system is a hook and loop system, a lacing cord system, a captured bead system, or an extruded track zipper system.

5. The flexible bag assembly of claim 1, wherein the body is manufactured from a material selected from the group consisting of fabric, fluoropolymers, Teflon PTFE, Teflon FEP, polypropylene, polyethylene, and polyvinyl chloride.

6. The flexible bag assembly of claim 1, wherein the closure system is in the configuration of a clam shell.

7. The flexible bag assembly of claim 1, further comprising:
a vacuum connection port and an air intake valve.

8. The flexible bag assembly of claim 7, wherein the vacuum connection port is ⅜″ in diameter, and the air intake valve is ⅜″ in diameter.

9. The flexible bag assembly of claim 7, wherein the vacuum connection port is 2″ in diameter, and the air intake valve is 2″ in diameter.

10. The flexible bag assembly of claim 7, further comprising a restricting valve at the air intake valve.

11. The flexible bag assembly of claim 1, wherein the flexible bag assembly has two tubular sections to wrap around two pipes connected to the container.

12. The flexible bag assembly of claim 1, further comprising a funnel shaped or bowl shaped extensions for collection and removal of solids and liquids.

13. A system for environmental process containment, comprising:
a bag assembly having a body, the body having a first end and a second end;
a closure system for opening or closing of the body between the first end and the second end along a seam; and
at least one tubular section on one end of the body; wherein the tubular section is configured to wrap around a pipeline connected to a container.

14. The system of claim 13, further comprising a canister having adsorption media.

15. The system of claim 14, wherein the adsorption media is carbon, resins, or zeolite.

16. The system of claim 13, wherein the container comprises a leaking pipe flange, a leaking valve, or a pipe connection.

17. A method of containing hazardous media from a container having a body and at least one pipe connected to the body, comprising:
wrapping the flexible bag assembly of claim 1 around the body of the container; wherein the at least one tubular section wraps around the at least one pipe; and
closing the body of the bag assembly around the body of the container using a closure system.

18. The method of claim 17, further comprising:
applying vacuum through a vacuum port on the bag assembly.
